(19) United States
(12) Patent Application Publication
(10) Pub. No.: US 2024/0072878 A1
(43) Pub. Date: Feb. 29, 2024

(54) METHOD AND APPARATUS FOR BEAM FAILURE RECOVERY

(71) Applicant: MEDIATEK INC., Hsin-Chu (TW)

(72) Inventors: Gyu Bum Kyung, San Jose (US); Cheng-Rung Tsai, Hsin-Chu (TW)

(21) Appl. No.: 18/464,215

(22) Filed: Sep. 9, 2023

Related U.S. Application Data
(63) Continuation of application No. 17/480,933, filed on Sep. 21, 2021, now abandoned.
(60) Provisional application No. 63/094,919, filed on Oct. 22, 2020.

(51) Int. Cl. H04B 7/08; H04L 5/00; H04W 56/00; H04W 76/19; H04W 80/02

(52) U.S. Cl. CPC H04B 7/088; H04L 5/0051; H04W 56/001; H04W 76/19; H04W 80/02

(57) ABSTRACT

A unified solution to support all PCell, SCell, and per-TRP based beam failure recovery (BFR) procedure is proposed, with less standard impact and reduced latency. In a first novel aspect, a set of reference signals (RSs) for BFD is configured for each BWP of a serving cell, and a maximum number of BFD RSs (N) per TRP for each BWP of a serving cell is configured. In a second novel aspect, for single DCI multi-TRP, the BFD RSs can be updated via MAC CE to reduce latency. In a third novel aspect, new RRC parameters for BFD RSs and candidate beam RSs are configured, with different sets of SSB/CSI-RS resources associated to each TRP. Specifically, an additional lists of SSB/CSI-RS resource set is defined for each corresponding TRP.

### CROSS REFERENCE TO RELATED APPLICATIONS

This application is a continuation, and claims priority under 35 U.S.C. § 120 from nonprovisional U.S. patent application Ser. No. 17/480,933, entitled “METHOD AND APPARATUS FOR BEAM FAILURE RECOVERY”, filed on Sep. 21, 2021, the subject matter of which is incorporated herein by reference. Application Ser. No. 17/480,933, in turn, claims priority under 35 U.S.C. § 119 from U.S. Provisional Application No. 63/094,919, entitled “Method and Apparatus for Beam Failure Recovery,” filed on Oct. 22, 2020, the subject matter of which is incorporated herein by reference.

### TECHNICAL FIELD

The disclosed embodiments relate generally to wireless communication, and, more particularly, to beam failure recovery procedure involving both primary cell and secondary cells and for multiple transmission points (TRPs) in new radio (NR) mobile communication networks.

### BACKGROUND

The fifth generation (5G) radio access technology (RAT) will be a key component of the modern access network. It will address high traffic growth and increasing demand for high-bandwidth connectivity. It will address high traffic growth, energy efficiency and increasing demand for high-bandwidth connectivity. It will also support massive numbers of connected devices and meet the real-time, high-reliability communication needs of mission-critical applications. In the legacy wireless communication, a user equipment (UE) is normally connected to a single serving base station and communicates with the serving base station for control and data transmission. The 5G network is designed with dense base station deployment and heterogeneous system design are deployed. Multiple-connection technologies, such as coordinated multipoint (CoMP) transmission, is expected to get more widely deployment to get higher data rate and higher spectral efficiency gains. The multiple-connection model for the wireless communicate requires UEs to coordinate with multiple transmission points (TRPs) for reporting and control information reception.

In milli-meter wave (mmWave) systems, beam management and beam training mechanism, which includes both initial beam alignment and subsequent beam tracking, ensures that base station (BS) beam and user equipment (UE) beam are aligned for data communication. To ensure beam alignment, beam-tracking operation should be adapted in response to channel changes. Beam failure recovery (BFR) mechanism is designed to handle the rare case beam tracking issue, e.g., when feedback rate for beam management and beam training may not be frequent enough. When beam failure is detected, UE triggers a beam failure recovery procedure and identifies a candidate beam for beam failure recovery. UE then starts beam failure recovery request (BFRQ) transmission on contention-free physical random-access channel (PRACH) resource corresponding to the identified candidate beam. BFR is completed when UE receives a BFR response (BFRR).

Under carrier aggregation (CA) and dual-connectivity (DC), the BFR procedure is typically supported by UE in primary cell (PCell) and primary secondary cell (PSCell), but not in secondary cells (SCells). It is necessary for UE to perform BFR in SCells so that beam failures occurred in secondary cells can also be detected and recovered. Furthermore, when multiple TRPs exist in the system, UE needs to support BFR for multi-TRP. If one of the TRPs failed, BFR is performed per-TRP by using the reliable link to other TRPs. A unified solution to support all PCell, SCell, and per-TRP based BFR is desired, with less standard impact and reduced latency.

### SUMMARY

A method of performing beam failure recovery (BFR) procedure that supports primary cell, secondary cell, and per-TRP based BFR is proposed. In a first novel aspect, a set of reference signals (RSs) for BFD is configured for each BWP of a serving cell, and a maximum number of BFD RSs (N) per TRP for each BWP of a serving cell is configured. In a second novel aspect, for single DCI multi-TRP, the BFD RSs can be updated via MAC CE to reduce latency. In a third novel aspect, new RRC parameters for BFD RSs and candidate beam RSs are configured, with different sets of SSB/CSI-RS resources associated to each TRP. Specifically, an additional lists of SSB/CSI-RS resource set is defined for each corresponding TRP. In another novel aspect, one more scheduling request IDschedulingRequestID-BFR-SCell-r16 is added in MAC-CellGroupConfig for LRR transmission per each cell for LRR transmission. In yet another novel aspect, one more candidate RS is added in BFR MAC CE per each cell for BFRQ transmission.

In one embodiment, a UE obtains a configuration of a set of beam failure detection (BFD) reference signals (RSs) in a beamforming communication network. The UE is configured to operate under multiple transmission points (TRPs). The UE performs BFD using the configured BFD RSs, and the configuration comprises a maximum number of BFD RSs for each TRP. The UE transmits a link recovery request (LRR) to the network for requesting an uplink resource. The UE transmits a beam failure recovery request (BFRQ) to the network over the requested uplink resource.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an LTE and NR beamforming wireless communication system and supporting beam failure recovery (BFR) procedure for multiple transmission points (TRP) in accordance with one novel aspect.

FIG. 2 is a simplified block diagram of a base station and a user equipment that carry out certain embodiments of the present invention.

FIG. 3 illustrates a sequence flow between a UE and a network supporting a beam failure recovery (BFR) procedure for both primary cell and secondary cell.

FIG. 4 illustrates a sequence flow between a UE and a network supporting a beam failure recovery (BFR) procedure for multiple TRPs.

FIG. 5 illustrates solutions for a per-TRP based BFR procedure supporting multiple TRPs in accordance with one novel aspect.

FIG. 6 is a flow chart of a method of per-TRP based beam failure recovery (BFR) procedure supporting multiple TRPs in a beamforming system in accordance with one novel aspect.

### DETAILED DESCRIPTION

Reference will now be made in detail to some embodiments of the invention, examples of which are illustrated in the accompanying drawings.

FIG. 1 illustrates a 5G new radio (NR) beamforming wireless communication system 100 and supporting beam failure recovery (BFR) procedure for multiple transmission points (TRP) in accordance with one novel aspect. Mobile communication network 100 comprises a first base station BS or a TRP 101, a second BS or a TRP 102, and a user equipment UE 103. In next generation 5G NR systems, a base station (BS) is referred to as a gNodeB or gNB. The base station performs beamforming in NR, e.g., in both FR1 (sub7 GHz spectrum) or FR2 (Millimeter Wave frequency spectrum). The NR beamforming cellular network uses directional communications with beamformed transmission and can support up to multi-gigabit data rate. Directional communications are achieved via digital and/or analog beamforming, wherein multiple antenna elements are applied with multiple sets of beamforming weights to form multiple beams.

In beamforming network, beam management and beam training mechanism, which includes both initial beam alignment and subsequent beam tracking, ensures that base station (BS) beam and user equipment (UE) beam are aligned for data communication. To ensure beam alignment, beam-tracking operation should be adapted in response to channel changes. A beam failure recovery (BFR) mechanism is designed to handle the rare case beam tracking issue, e.g., when feedback rate for beam management and beam training may not be frequent enough. When beam failure on all serving links for control channels, UE identifies one or more new candidate beams for beam failure recovery. Note that beam failure detection (BFD) and new candidate beam identification (CBD) can be performed sequentially or simultaneously. UE then initiates a BFR procedure and starts a beam failure recovery request (BFRQ) transmission on a dedicated physical random-access channel (PRACH) resource corresponding to one of the identified new candidate beams. UE monitors network response to decide whether the BFR procedure is completed.

Under carrier aggregation (CA) and dual-connectivity (DC), the BFR procedure is typically supported by UE in primary cell (PCell) and primary secondary cell (PSCell), but not in secondary cells (SCells). It is necessary for UE to perform BFR in SCells so that beam failures occurred in secondary cells can also be detected and recovered. Furthermore, when multiple TRPs exist in the system, UE needs to support BFR for multi-TRP. If one of the TRPs failed, BFR is performed per-TRP by using the reliable link to other TRPs. In accordance with one novel aspect, a unified solution to support all PCell, SCell, and per-TRP based BFR is proposed, with less standard impact and reduced latency.

In the example of FIG. 1, a per-TRP based BFR procedure for is depicted by 110. UE 103 is configured to operate under multiple TRPs (e.g., TRP #1 and TRP #2). If one of the TRP fails, then BFR is performed per-TRP by using the reliable link to the other TRP. In a first novel aspect, a set of reference signals (RSs) for BFD is configured for each BWP of a serving cell, and a maximum number of BFD RSs (N) per TRP for each BWP of a serving cell is configured. In a second novel aspect, for single DCI multi-TRP, the BFD RSs can be updated via MAC CE to reduce latency. In a third novel aspect, new RRC parameters for BFD RSs and candidate beam RSs are configured, with different sets of SSB/CSI-RS resources associated to each TRP. Specifically, an additional lists of SSB/CSI-RS resource set is defined for each corresponding TRP. In another novel aspect, one more scheduling request IDschedulingRequestID-BFR-SCell-r16 is added in MAC-CellGroupConfig for LRR transmission per each cell for LRR transmission. In yet another novel aspect, one more candidate RS is added in BFR MAC CE per each cell for BFRQ transmission.

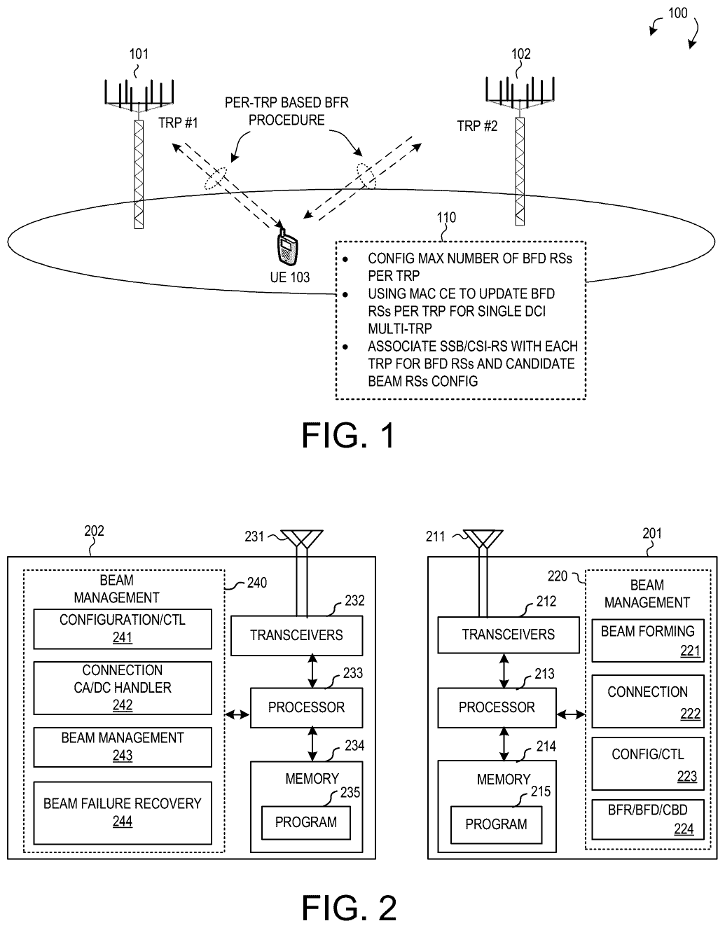

FIG. 2 is a simplified block diagram of a base station 201 and a user equipment 202 that carry out certain embodiments of the present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules and circuits that carry out different tasks in accordance with embodiments of the current invention.

Similarly, UE 202 has an antenna array 231, which transmits and receives radio signals. RF transceivers module 232, coupled with the antenna array, receives RF signals from antenna array 231, converts them to baseband signals and sends them to processor 233. RF transceivers 232 also converts received baseband signals from processor 233, converts them to RF signals, and sends out to antenna array 231. Processor 233 processes the received baseband signals and invokes different functional modules to perform features in UE 202. Memory 234 stores program instructions and data 235 to control the operations of UE 202. UE 202 also includes multiple function modules and circuits that carry out different tasks in accordance with embodiments of the current invention.

The functional modules and circuits can be implemented and configured by hardware, firmware, software, and any combination thereof. For example, BS 201 comprises a beam management module 220, which further comprises a beam forming circuit 221, a connection handling module 222, a configuration and control circuit 223, and a BFR handling module 224. Beamforming circuit 221 may belong to part of the RF chain, which applies various beamforming weights to multiple antenna elements of antenna 211 and thereby forming various beams. Connection handling module 222 establishes connections for different serving cells. Config and control circuit 223 provides configuration and control information to UEs. BFR handling module 224 performs physical layer radio link monitor, measurements, and beam failure recovery functionality in both PCell, PSCell, and SCells and for multiple TRPs on per-TRP basis.

Similarly, UE 202 comprises a beam management module 240, which further comprises a beam management module 240, which further comprises a beam forming circuit 241, a connection handling module 242, a configuration and control circuit 243, and a BFR handling module 244. Beamforming circuit 241 may belong to part of the RF chain, which applies various beamforming weights to multiple antenna elements of antenna 231 and thereby forming various beams. Connection handling module 242 establishes connections for different serving cells. Config and control circuit 243 receives configuration and control information from its serving BS. BFR handling module 244 performs physical layer radio link monitor, measurements, and beam failure recovery functionality in both PCell, PSCell, and SCells and for multiple TRPs on per-TRP basis.

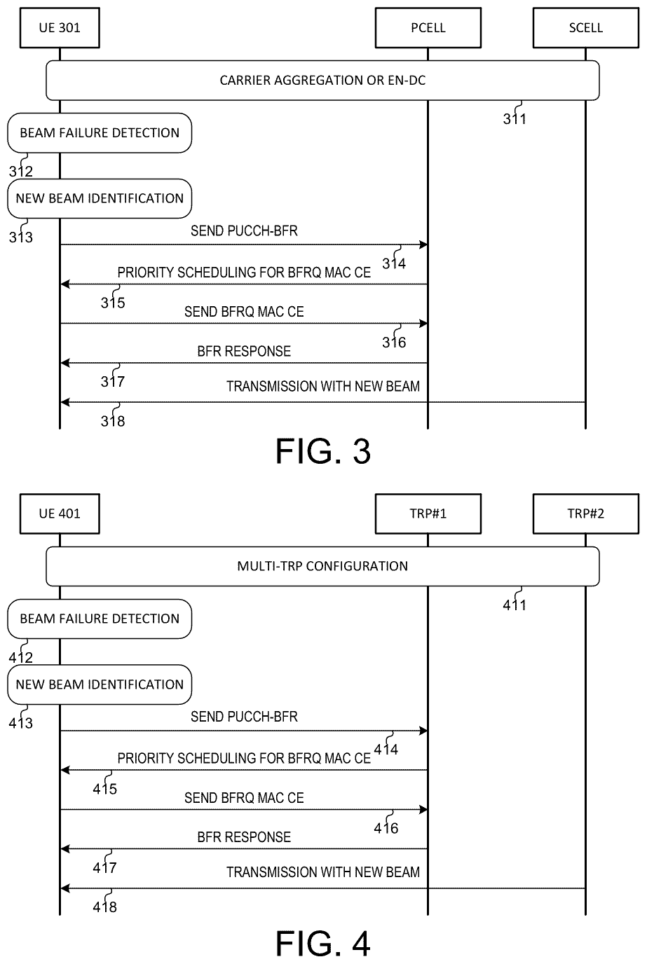

FIG. 3 illustrates a sequence flow between a UE and a network supporting a beam failure recovery (BFR) procedure for both primary cell and secondary cell. In step 311, UE 301 is configured to operate in multiple FR bands (e.g., LTE/NR FR1 and FR2) under carrier aggregation (CA) or dual-connectivity (DC). Under CA, UE 301 establishes multiple connections in a primary cell (PCell) and one or more secondary cells (SCells). Under DC, UE 301 establishes multiple connections in a primary cell (PCell), a primary secondary cell (PSCell), and one or more secondary cells (SCells). A BFR procedure is designed to handle the rare case beam tracking issue, e.g., when feedback rate for beam management and beam training may not be frequent enough. In step 312, UE 301 performs beam failure detection (BFD) over both PCell, PSCell, and SCells. In step 313, UE 301 performs new beam identification, or candidate beam detection (CBD). In step 314, UE 301 sends a BFR indication over PUCCH of the primary cell if the beam failure occurs in the SCell. In step 315, UE 301 receives a BFR request (BFRQ) scheduling via MAC CE. In step 316, UE 301 sends the BFRQ with detailed information via MAC CE over the scheduled resource (guaranteed). In step 317, UE 301 receives a BFR response from the network with new beam information of the SCell. In step 318, UE 301 can start data transmission using the new beam in the SCell.

FIG. 4 illustrates a sequence flow between a UE and a network supporting a beam failure recovery (BFR) procedure for multiple TRPs. Similar BFR procedures illustrated in FIG. 3 may be applied for FIG. 4. If one of the TRP fails, then BFR is performed per-TRP by using the reliable link to the other TRP. In step 411, UE 401 is configured for multi-TRP operation, with TRP #1 and TRP #2. The BFR procedure is performed from step 412 to step 418, which is similar to the BFR procedure performed from step 312 to 318 in FIG. 3. In FIG. 4, however, instead of performing BFR for secondary cell using primary cell, the BFR is performed on a per-TRP basis, by using a reliable link of one TRP to recover the beam failure detected in another TRP. In order to support multi-TRP BFR procedure for each TRP, the reference signals (RSs) used for beam failure detection (BFD) need to be configured per TRP basis, and new parameters for BFD RSs and candidate beams RSs need to be introduced.

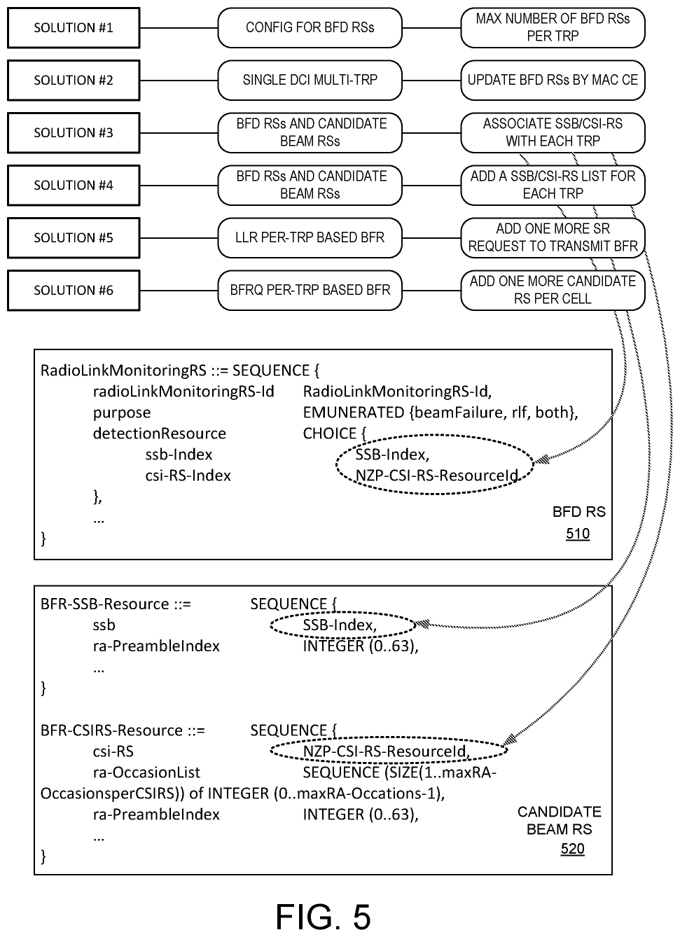

FIG. 5 illustrates solutions for a per-TRP based BFR procedure supporting multiple TRPs in accordance with one novel aspect. In a first solution #1, a set of reference signals (RSs) for BFD is configured for each BWP of a serving cell. In Rel-15 and Rel-16, a UE can be provided a set q̅₀̅ as BFD RSs for each BWP of a serving cell explicitly by RRC configuration or implicitly by TCI-State for CORESETs. The set q̅₀̅ can include up to two BFD RSs. However, if the same number of BFD RSs for multi-TRP in Rel-17 is used, then the number of BFD RSs can be only one per TRP. This number may not be enough considering there can be up to two BFD RSs for a single TRP. Therefore, it is proposed that a maximum number of BFD RSs (e.g., N>=2) per TRP for each BWP of a serving cell is configured by the network for the UE.

In a second solution #2, for single DCI multi-TRP, the BFD RSs can be updated via MAC CE to reduce latency. In OFDM systems, a physical downlink control channel (PDCCH) is associated with a search space, which in turn is associated with a control resource set (CORESET). Downlink control information (DCI) carried by PDCCH can come from different TRPs. For multi DCI multi-TRP, each TRP has a corresponding CORESET, and the transmission configuration indication (TCI) state for CORESETs can be used to implicitly configure BFD RSs. However, for single DCI multi-TRP, such implicit configuration for BFD RSs that follows the TCI state for CORESETs cannot be used. This is because only the anchor TRP has a corresponding CORESET for single DCI multi-TRP. If only explicit RRC configuration is relied on for BFD RSs, it is hard to update BFD RS when the serving beam changes due to UE's movement, since RRC reconfiguration leads to a lot of latency. As a result, it is proposed that BFD RSs can be updated by MAC CE during a per-TRP based BFR procedure to reduce latency, especially for single DCI multi-TRP.

In a third solution #3, new RRC parameters for BFD RSs and candidate beam RSs are configured, with different sets of SSB/CSI-RS resources associated to each TRP. For multi-TRP, the gNB configures the different sets of SSB/CSI-RS resources for each TRP. However, the UE doesn't know which SSB/CSI-RS resources belong to which TRP. Accordingly, the index of SSB or CSI-RS resources can be used in the RRC configuration for BFD RSs, as depicted by 510, and the index of SSB or CSI-RS resources can be used in the RRC configuration for candidate beam RS, as depicted by 520. The different indexes of SSB or CSI-RS resources are mapped to corresponding TRPs, so that the UE can identify which SSB or CSI-RS resources are used for which TRP for BFD or CBD purposes.

In a fourth solution #4, new RRC parameters for BFD RSs and candidate beam RSs are configured, with different sets of SSB/CSI-RS resources associated to each TRP. Specifically, an additional lists of SSB/CSI-RS resource set is defined for each corresponding TRP. All resources in these additional sets are associated with another TRP in addition to a serving TRP.

In a fifth solution #5, regarding link recovery request (LRR), the UE can be configured with schedulingRequestID-BFR-SCell-r16 to request uplink resource to transmit BFR MAC CE. There is only one schedulingRequestID-BFR-SCell-r16 in MAC-CellGroupConfig, which means that the gNB can only configure one LRR per cell group. However, beam failure can happen at either of TRPs. If this LRR can be only transmitted to one TRP, then the UE cannot transmit LRR using PUCCH resource targeted to another TRP in good channel condition when the TRP configured with LRR has beam failure. Therefore, it is proposed to add one more scheduling request IDschedulingRequestID-BFR-SCell-r16 in MAC-CellGroupConfig for LRR transmission per each cell.

In a sixth solution #6, the BFR MAC CE for SCell BFR in Rel-16 can be reused. It can be noted that the BFR MAC CE can be also used for contention-based RACH for SpCell. However, the UE can only report one candidate RS in current spec. If one more candidate RS for another TRP is added, then the BFR MAC CE can be used when both TRPs are failed. When the UE reports only one candidate RS, the gNB know which TRP is failed implicitly by checking the lists of SSB/CSI resource sets. It is thus proposed to add one more candidate RS in BFR MAC CE per each cell.

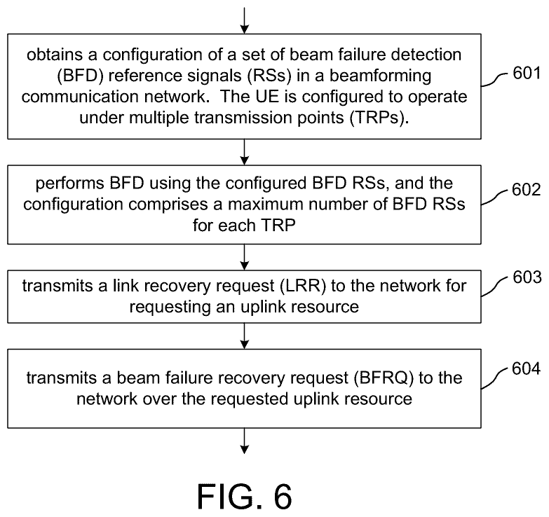

FIG. 6 is a flow chart of a method of per-TRP based beam failure recovery (BFR) procedure supporting multiple TRPs in a beamforming system in accordance with one novel aspect. In step 601, a UE obtains a configuration of a set of beam failure detection (BFD) reference signals (RSs) in a beamforming communication network. The UE is configured to operate under multiple transmission points (TRPs). In step 602, the UE performs BFD using the configured BFD RSs, and the configuration comprises a maximum number of BFD RSs for each TRP. In step 603, the UE transmits a link recovery request (LRR) to the network for requesting an uplink resource. In step 604, the UE transmits a beam failure recovery request (BFRQ) to the network over the requested uplink resource.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method of performing a beam failure recovery (BFR) procedure, the method comprising:
obtaining a configuration of a set of beam failure detection (BFD) reference signals (RSs) by a user equipment (UE) in a beamforming communication network;
performing BFD using the configured BFD RSs, wherein the configuration comprises a maximum number of BFD RSs, wherein the BFD RSs are explicitly configured via a radio resource control (RRC) signaling, and wherein the configured BFD RSs are updated by MAC CE;
transmitting a link recovery request (LRR) to the network for requesting an uplink resource; and
transmitting a beam failure recovery request (BFRQ) to the network over the requested uplink resource.

2. The method of claim 1, wherein the BFD RSs is implicitly configured via a transmission configuration indication (TCI) state for a corresponding control resource set (CORESET).

3. The method of claim 1, further comprising:
receiving a set of radio resource control (RRC) parameters for the BFD RSs and candidate beam RSs, wherein the set of RRC parameters comprises a list of synchronization signal block (SSB) or channel state information RS (CSI-RS) resource indexes.

4. The method of claim 3, wherein the list of SSB or CSI-RS resource indexes is associated with a transmission point (TRP).

5. The method of claim 3, wherein an additional list of SSB or CSI-RS resources is defined for both a serving transmission point (TRP) and another TRP.

6. The method of claim 1, wherein the LRR has a scheduling request ID that identifies a corresponding transmission point (TRP) with a detected beam failure.

7. The method of claim 1, wherein the BFRQ comprises candidate beam information and is transmitted via a MAC control element (CE).

8. The method of claim 7, wherein the BFRQ comprises a candidate RS for a corresponding transmission point (TRP) with a detected beam failure.

9. A User Equipment (UE), comprising:
a configuration and control circuit that obtains a configuration of a set of beam failure detection (BFD) reference signals (RSs) in a beamforming communication network;
a beam failure recovery (BFR) handling circuit that performs BFD using the configured BFD RSs, wherein the configuration comprises a maximum number of BFD RSs, wherein the BFD RSs are explicitly configured via a radio resource control (RRC) signaling, and wherein the configured BFD RSs are updated by MAC CE; and
a transmitter that transmits a link recovery request (LRR) to the network for requesting an uplink resource, and the transmitter also transmits a beam failure recovery request (BFRQ) to the network over the requested uplink resource.

10. The UE of claim 9, wherein the BFD RSs is implicitly configured via a transmission configuration indication (TCI) state for a corresponding control resource set (CORESET) of each TRP.

11. The UE of claim 9, further comprising:
a receiver that receives a set of radio resource control (RRC) parameters for the BFD RSs and candidate beam RSs, wherein the set of RRC parameters comprises a list of synchronization signal block (SSB) or channel state information RS (CSI-RS) resource indexes.

12. The UE of claim 11, wherein the list of SSB or CSI-resource indexes is associated with a transmission point (TRP).

13. The UE of claim 11, wherein an additional list of SSB or CSI-RS resources is defined for both a serving transmission point (TRP) and another TRP.

14. The UE of claim 9, wherein the LRR has a scheduling request ID that identifies a corresponding transmission point (TRP) with a detected beam failure.

15. The UE of claim 9, wherein the BFRQ comprises candidate beam information and is transmitted via a MAC control element (CE).

16. The UE of claim 15, wherein the BFRQ comprises a candidate RS for a corresponding transmission point (TRP) with a detected beam failure.
